(19) United States
(12) Patent Application Publication
(10) Pub. No.: US 2026/0180350 A1
(43) Pub. Date: Jun. 25, 2026

(54) MODULAR TRAVEL CHARGER SYSTEM FOR PORTABLE RADIOS

(71) Applicant: MOTOROLA SOLUTIONS, INC., Chicago, IL (US)

(72) Inventors: Yew Vui Leong, Kota Kinabalu (MY); Cheah Chan Kee, Gelugor (MY); Soon Hin Lee, Penang (MY); Tze Ming Lee, Kuala Lumpur (MY); Felippe Morais Bicudo, Ave Maria, FL (US); Ryan M. Nilsen, Plantation, FL (US)

(21) Appl. No.: 18/987,804

(22) Filed: Dec. 19, 2024

(51) Int. Cl. H02J 7/00

(52) U.S. Cl. CPC H02J 7/751; H02J 7/50; H02J 7/80

(57) ABSTRACT

A travel charger system is for a first battery having contacts and a latch to secure to a first portable radio and a second battery having contacts and a latch to secure to a second portable radio. The travel charger system includes a charger base having charging circuitry, charging contacts, and a power input, and a slide holder configured to engage the charger base in a first position to support the first battery in a charging state and a second position to separately support the second battery in a charging state, the slide holder having an aperture configured to engage the latch of the first battery in the first position and the latch of the second battery in the second position.

### FIELD OF INVENTION

The present disclosure relates to charging systems for portable electronic devices, and more particularly to a modular travel charger system for charging batteries and portable radios with different form factors.

### BACKGROUND

Portable electronic devices, such as two-way radios, have become essential tools for many professionals, including first responders, security personnel, and industrial workers. These devices often rely on rechargeable batteries to provide power for extended periods of use in the field. As the functionality and power requirements of portable radios have increased, so too has the need for efficient and versatile charging solutions.

### BRIEF DESCRIPTION OF FIGURES

Non-limiting and non-exhaustive examples are described with reference to the following figures.

FIG. 1A illustrates a perspective view of a first travel charger system having a charger base and a first slide holder.

FIG. 1B illustrates a perspective view of a second travel charger system having the charger base of FIG. 1A and a second slide holder.

FIG. 1C illustrates a perspective view of a third travel charger system having the charger base of FIG. 1A and a third slide holder.

FIG. 2 illustrates a perspective view of the charger base for a travel charger system.

FIG. 3A illustrates an exploded perspective view of the first travel charger system of FIG. 1A.

FIG. 3B illustrates an exploded perspective view of the second travel charger system of FIG. 1B.

FIG. 3C illustrates an exploded perspective view of the third travel charger system of FIG. 1C.

FIG. 4A illustrates a front perspective view of the second slide holder.

FIG. 4B illustrates a rear perspective view of the second slide holder.

FIG. 5A illustrates a first perspective view of a first battery receivable within the first slide holder.

FIG. 5B illustrates a second perspective view of the first battery receivable within the first slide holder.

FIG. 6 illustrates a perspective view of the travel charger system of FIG. 1A with the first battery of FIGS. 5A-5B in a charging position.

FIG. 7A illustrates a first perspective view of a second battery receivable within the first slide holder.

FIG. 7B illustrates a second perspective view of the second battery receivable within the first slide holder.

FIG. 8 illustrates a perspective view of the travel charger system of FIG. 1A with the second battery of FIGS. 7A-7B in a charging position.

FIG. 9A illustrates a perspective view of the insertion of a battery into the travel charger system of FIG. 1A.

FIG. 9B illustrates a sectional side view of the insertion of the battery into the travel charger system of FIG. 1A.

FIG. 10A illustrates a first perspective view of a third battery receivable within the first slide holder.

FIG. 10B illustrates a second perspective view of the third battery receivable within the first slide holder.

FIG. 11 illustrates a perspective view of the travel charger system of FIG. 1A with the third battery of FIGS. 10A-10B in a charging position.

FIG. 12 illustrates a front perspective view of the travel charger system of FIG. 1A in a position to receive the third battery.

FIG. 13 illustrates a rear perspective view of the travel charger system illustrated in FIG. 12.

FIG. 14A illustrates a front perspective view of the travel charger system of FIG. 1C with a radio device installed.

FIG. 14B illustrates a rear perspective view of the travel charger system of FIG. 1C with the radio device installed.

FIG. 14C illustrates a rear perspective view of the third slide holder.

FIG. 15A illustrates a front view of the charger base of FIG. 2 with an indicator panel.

FIG. 15B illustrates a perspective view of the first slide holder and a window of the same through which the indicator panel of FIG. 15A is visible.

FIG. 16A illustrates a first mounting configuration for the travel charger systems of FIGS. 1A-1C, the first mounting configuration including a belt clip.

FIG. 16B illustrates a second mounting configuration for the travel charger systems of FIGS. 1A-1C, the second mounting configuration including a magnetic mount.

FIG. 16C illustrates a third mounting configuration for the travel charger systems of FIGS. 1A-1C, the third mounting configuration including a ram mount.

FIG. 16D illustrates a fourth mounting configuration for the travel charger systems of FIGS. 1A-1C, the fourth mounting configuration including a stud mount.

FIG. 16E illustrates a fifth mounting configuration for the travel charger systems of FIGS. 1A-1C, the fifth mounting configuration including a hook and loop mount.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Charging systems for portable radios and their batteries have traditionally been designed to accommodate specific models or form factors. This approach often results in the need for multiple chargers to support different radio models or battery types within an organization. Such proliferation of charging devices can lead to increased costs, storage challenges, and logistical complexities for users who must manage various charging solutions.

Travel chargers, in particular, present unique challenges in the realm of portable radio power management. These devices must balance the need for compact, lightweight design with the ability to securely hold and charge batteries or radios in potentially unstable environments, such as moving vehicles. Additionally, travel chargers must often contend with space constraints and varying mounting requirements across different vehicle types or workspaces.

The diversity of battery sizes and form factors among portable radio models further complicates the design of universal charging solutions. Batteries may vary in dimensions, contact placements, and latching mechanisms, making it difficult to create a single charger that can accommodate multiple battery types without compromising security or charging efficiency.

Furthermore, users of portable radios often have varying preferences for charging configurations. Some may prefer to charge batteries separately from their radios, while others may need to charge the entire radio unit with the battery attached. This variability in user needs adds another layer of complexity to the design of versatile charging systems.

As organizations increasingly rely on a mix of radio models to meet their communication needs, there is a growing demand for charging solutions that can adapt to different device form factors and battery types. Such adaptability could potentially reduce the number of distinct charging devices required, simplify inventory management, and provide greater flexibility for users in the field.

According to an aspect of the present disclosure, a travel charger system for a first battery having contacts and a latch to secure to a first portable radio and a second battery having contacts and a latch to secure to a second portable radio is provided. The travel charger system includes a charger base having charging circuitry, charging contacts, and a power input. The travel charger system also includes a slide holder configured to engage the charger base in a first position to support the first battery in a charging state and a second position to separately support the second battery in a charging state. The slide holder has an aperture configured to engage the latch of the first battery in the first position and the latch of the second battery in the second position.

According to other aspects of the present disclosure, the travel charger system may include one or more of the following features. The slide holder may be configured to slide along the charger base from the first position to the second position. The travel charger system may further include a locking mechanism movable between an unlocked position in which the slide holder is movable along the charger base between the first position to the second position and a locked position in which the slide holder is precluded from movement along the charger base. The slide holder may include a U-shaped bracket extending away from the charger base, the U-shaped bracket and charger base defining a channel therebetween, wherein the channel is configured to separately receive the first battery when the contacts of the first battery engage the charging contacts and the second battery when the contacts of the second battery engage the charging contacts.

The charger contacts may extend through one or more openings formed in a planar surface of the charger base, and the travel charger system may further include a lip positioned adjacent the charging contacts of the charger base and protruding outward relative to the planar surface, wherein the lip prevents insertion of the first battery and the second battery into the slide holder in a direction parallel to the planar surface to prevent engagement between the charging contacts and a portion of the battery. The travel charger system may further include a battery indicator having a first portion that provides information for the first battery and a second portion that provides information for the second battery, the battery indicator coupled to the charger base, and an indicator aperture formed in the slide holder. In the first position, the indicator aperture may align with the first portion of the battery indicator and the slide holder may cover the second portion, and in the second position, the indicator aperture may align with the second portion of the battery indicator and the slide holder may cover the first portion of the battery indicator. The charger base may include a front surface at the charging contacts and a rear surface opposite the front surface, wherein the slide holder engages the front surface and the rear surface of the charger base.

According to another aspect of the present disclosure, a method of charging a first battery and a second battery is provided. The method includes inserting the first battery into a channel defined between a slide holder and a charger base such that contacts of the first battery engage charging contacts of the charger base and a latch of the first battery engages an aperture of the slide holder. The method also includes removing the first battery from the channel, moving the slide holder relative to the charger base from a first position to a second position to increase a distance between the contacts of the charger base and the aperture of the slide holder, and inserting the second battery between the slide holder and the charger base such that contacts of the second battery engage the charging contacts of the charger base and a latch of the second battery engages the aperture of the slide holder.

According to other aspects of the present disclosure, the method may include one or more of the following features. The method may further include, prior to moving the slide holder relative to the charger base, moving a locking mechanism from a locked position to an unlocked position to permit movement of the slide holder relative to the charger base. The method may further include, prior to inserting the second battery between the slide holder and the charger base, moving the locking mechanism from the unlocked position to the locked position to preclude movement of the slide holder relative to the charger base. Inserting the first battery into the channel may include inserting the first battery into the channel at an angle relative to an orientation of the first battery when the contacts of the first battery engage charging contacts of the charger base and the latch of the first battery engages the aperture of the slide holder such that engagement between the charging contacts and a leading edge of the first battery is prevented. Removing the first battery from the channel may include disengaging the latch of the first battery engages from the aperture of the slide holder. The method may further include providing a visual indication of the first battery when the slide holder is in the first position and providing a visual indication of the second battery when the slide holder is in the second position.

According to another aspect of the present disclosure, a travel charger system configured to perform the method described above is provided.

According to another aspect of the present disclosure, a modular charging system for a battery of a portable radio is provided, the battery having a latch to couple the battery to the portable radio. The modular charging system includes a charger base comprising charging circuitry and charging contacts. The modular charging system also includes a first slide holder removably coupled to the charger base at a first position and configured to support the battery in a charging state at the charging contacts, the slide holder having an aperture configured to engage the latch of the battery in the first position. The modular charging system further includes a second slide holder separate from the first slide holder and removably coupled to the charger base and configured to support the battery in a charging state at the charging contacts when the latch of the battery is coupled to the portable radio. The first slide holder is precluded from supporting the battery in a charging state when the latch of the battery is coupled to the portable radio.

According to other aspects of the present disclosure, the modular charging system may include one or more of the following features. Each slide holder of the first and second slide holders may include a locking mechanism movable between an unlocked position in which the respective slide holder is movable along the charger base and a locked position in which the respective slide holder is precluded from movement along the charger base. The first slide holder may be adjustable relative to the charger base from the first position to a second position in which a distance between the charging contacts of the charger base and the aperture of the first slide holder is increased, wherein the first slide holder is configured to be held in the first position and the second position. The first slide holder may include a U-shaped bracket, wherein the U-shaped bracket and charger base define a channel therebetween, wherein the channel is configured to receive the battery when the battery is in the charging state. The second slide holder may include a cradle configured to receive the battery and the portable radio. The charger base may include a first lengthwise end and a second lengthwise end, opposite the first lengthwise end, wherein the charging contacts are located nearer the first lengthwise end than the second lengthwise end, wherein, with the first slide holder coupled to the charger base, the battery is movable towards the second lengthwise end to engage the charging contacts in the charging state, and wherein, with the second slide holder coupled to the charger base, the battery is movable towards the first lengthwise end to engage the charging contacts in the charging state.

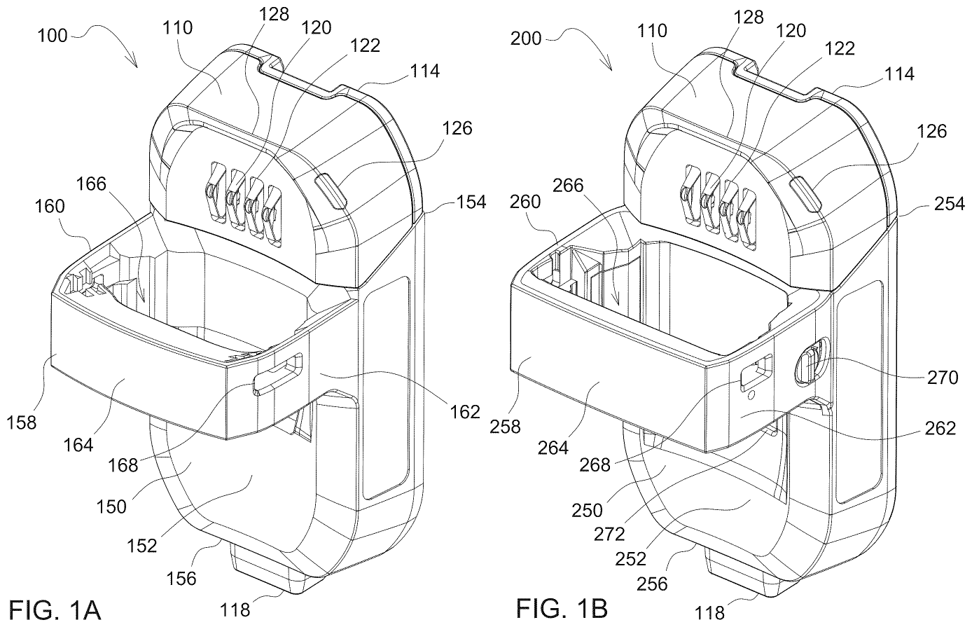

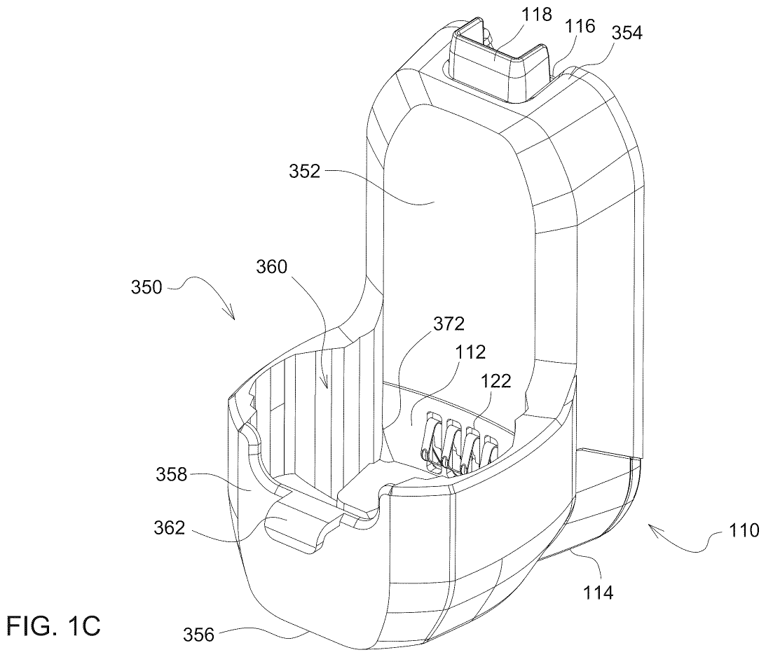

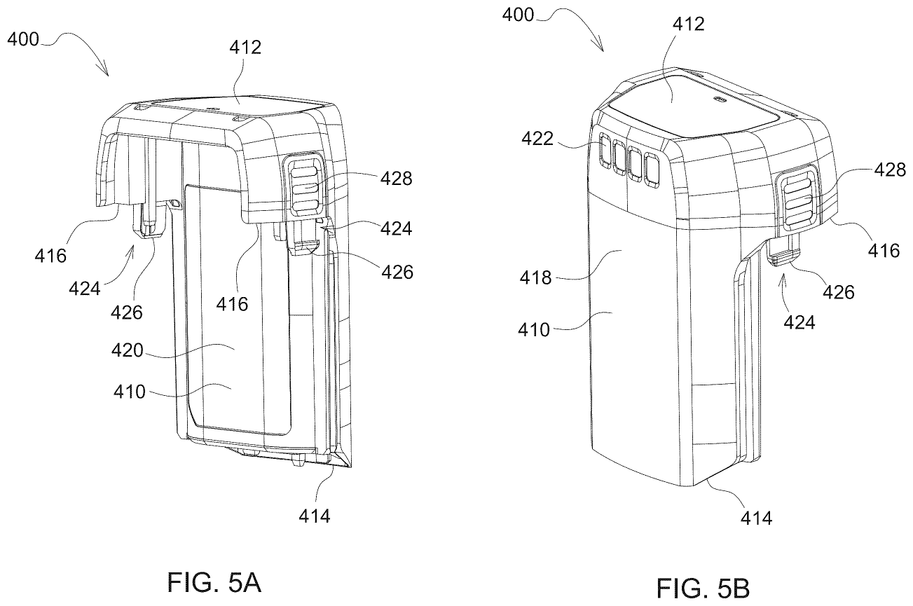

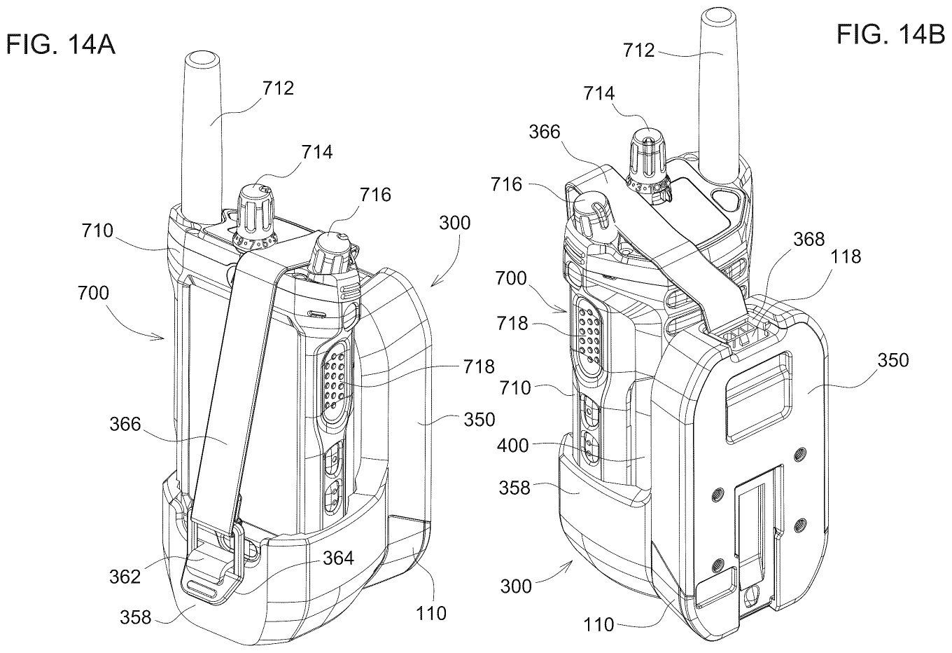

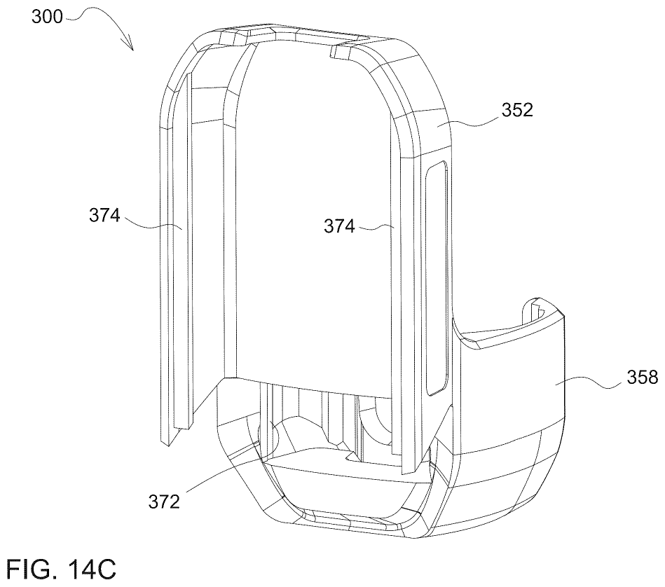

FIG. 1A illustrates a travel charger system 100 for charging batteries 400, 500, 600 (FIGS. 5A-11) of portable radios 700 (FIGS. 14A-14B). The travel charger system 100 includes a charger base 110 and a slide holder 150. The slide holder 150 in FIG. 1A is a first slide holder 150 to couple with the charger base 110. FIG. 1B illustrates a second slide holder 250 for coupling with the base 110 to form a second travel charger system 200. FIG. 1C illustrates a third slide holder 350 for coupling with the base 110 to form a third travel charger system 300.

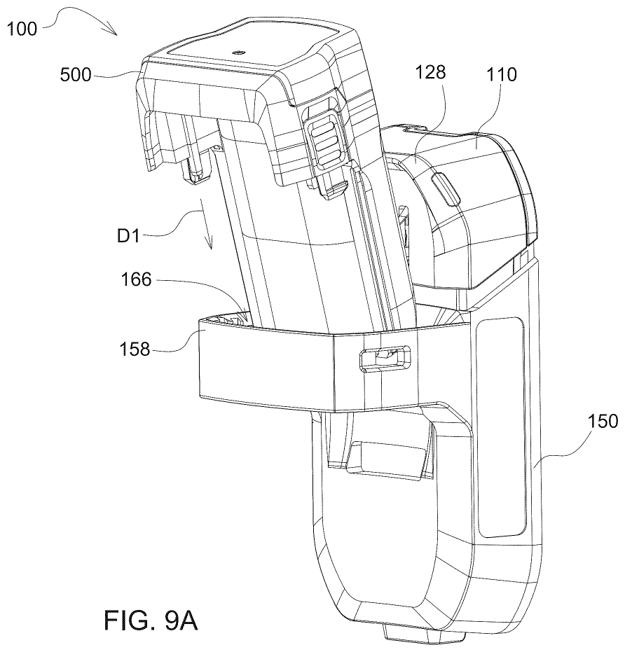

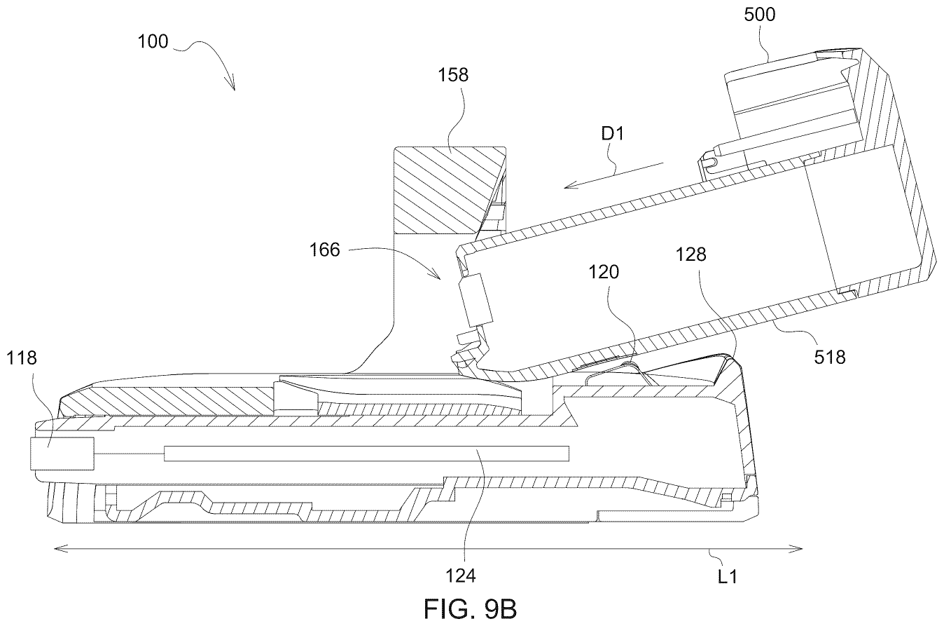

The charger base 110 includes charging circuitry 124 (FIG. 9B), charging contacts 120, and a power input 118. The charger base 110 is designed to accept different slide holders including the first slide holder 150, the second slide holder 250, and the third slide holder 350. These slide holders 150, 250, 350 may accommodate different battery sizes and configurations.

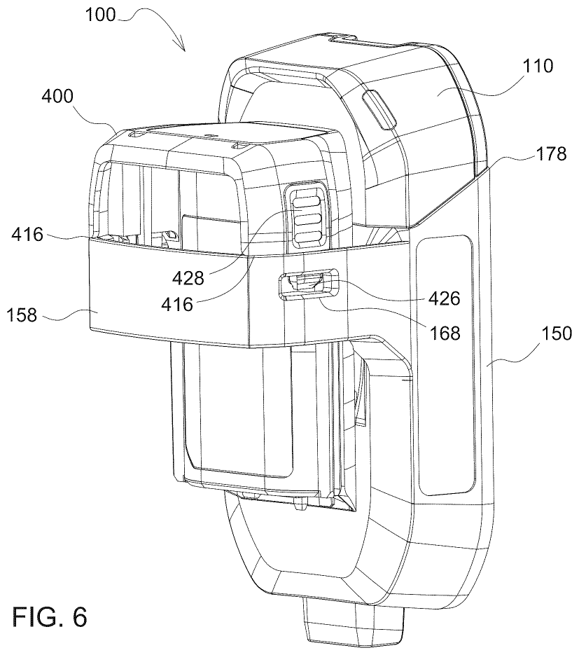

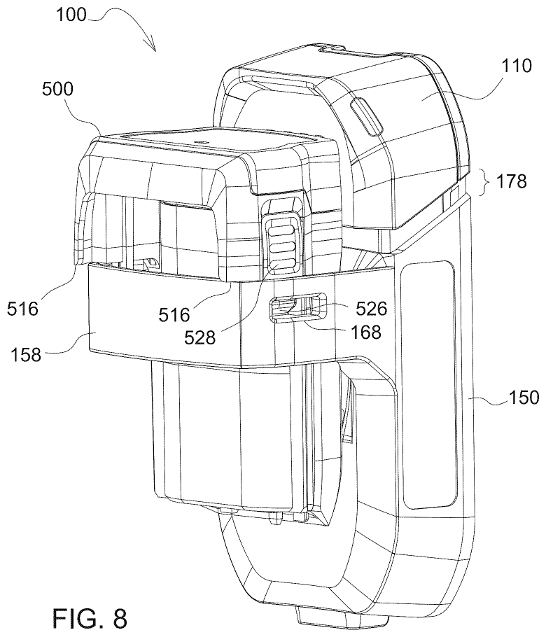

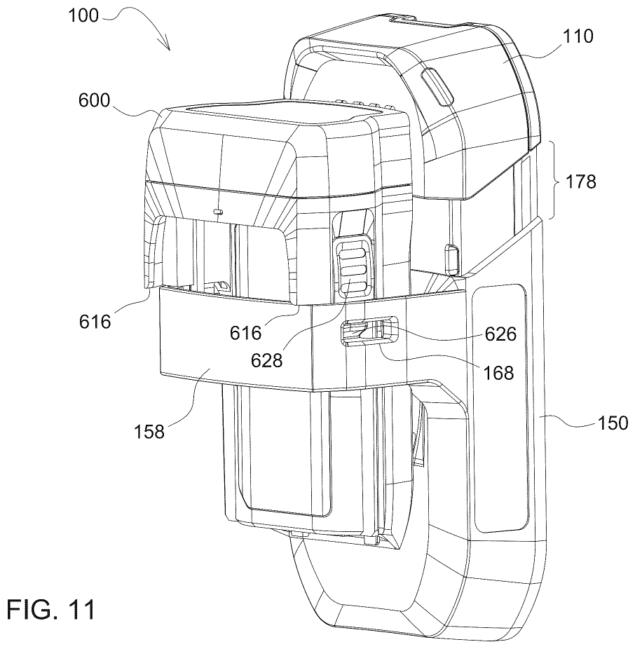

Each of the slide holders 150, 250, 350 is also configured to engage the charger base 110 in various positions to accommodate batteries of different sizes. First, second, and third positions are illustrated and described with respect to the first slide holder 150, though is also achieved with the second and third slide holders 250, 350. In a first position (FIG. 6), the travel charger system 100 supports a first battery 400. In a second position (FIG. 8), the travel charger system 100 supports a second battery 500. In a third position (FIG. 11), the travel charger system 100 supports a third battery 600.

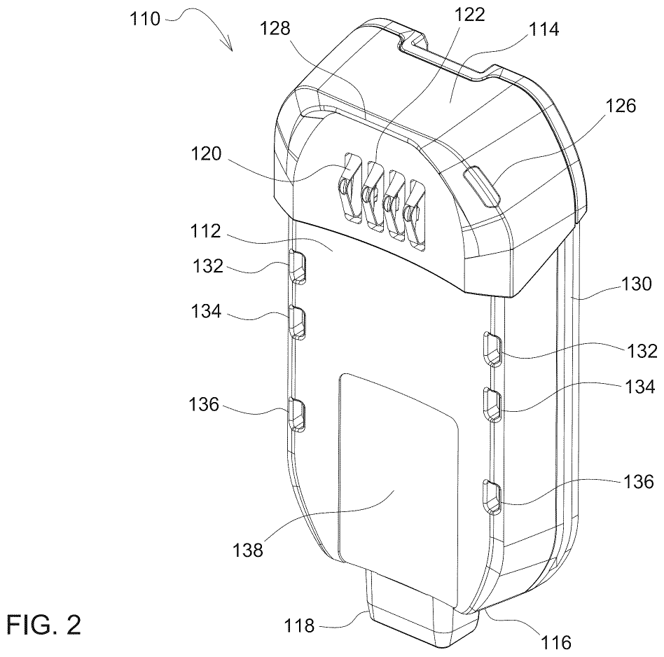

FIG. 2 illustrates a perspective view of the charger base 110 of the travel charger system 100. The charger base 110 includes a housing 112 with a first longitudinal end 114 and a second longitudinal end 116, opposite the first longitudinal end 114. The charger base 110 includes charging contacts 120 located nearer the first longitudinal end 114 than the second longitudinal end 116. The charging contacts 120 extend through one or more apertures 122 formed in a planar surface of the housing 112 of the charger base 110 such that the charging contacts are externally accessible to charge a battery 400, 500, 600. The charging contacts 120 are electrically coupled to charging circuitry 124 located within the housing 112 and to the power input 118 via the charging circuitry 124 to facilitate charging of the battery 400, 500, 600.

The charger base 110 includes a lip 128 positioned adjacent the charging contacts 120 (e.g., between the first longitudinal end 114 and the charging contacts 120) and protruding outward relative to the planar surface. The lip 128 prevents insertion of a battery 400, 500, 600 into a slide holder 150, 250 in a direction parallel to the planar surface to prevent engagement between the charging contacts 120 and a portion of the battery 400, 500, 600 (e.g., an outer surface 418, 518, 618 of the respective battery). An indicator light 126 is positioned adjacent the first longitudinal end 114 of the charger base 110. The indicator light 126 may display charging status or other information related to the operation of the travel charger system 100.

The charging contacts 120 are located on a front surface of the charger base 110, with a rear surface of the charger base 110 located opposite the front surface. Sides of the charger base 110 running longitudinally between the ends 114, 116 include channels 130 running from adjacent the second longitudinal end 116 towards the first longitudinal end 114. These channels 130 receive rails 174, 274, 374 of the slide holders 150, 250, 350 for coupling and alignment with the charger base 110.

On the same side of the charger base 110 as the charging contacts 120, the charger base 110 includes a series of locking slots: upper locking slots 132, middle locking slots 134, and lower locking slots 136. These locking slots allow for adjustable positioning of the slide holders 150, 250, 350, at different heights along the charger base 110 to accommodate batteries 400, 500, 600 of different lengths and form factors.

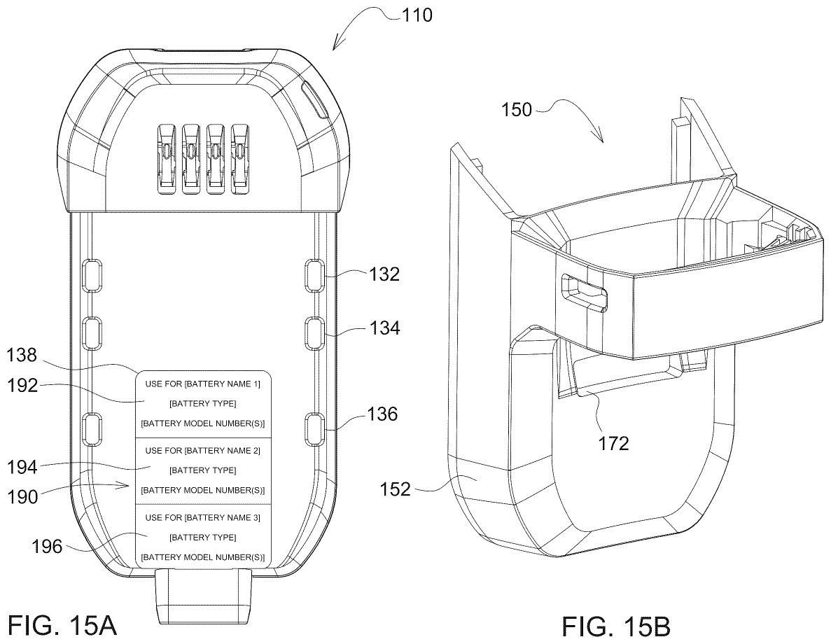

The front face of the charger base 110 includes a recessed area 138, formed as a generally rectangular recess with a relatively small depth (relative to the width and length) to accommodate an indicator panel 190 (FIG. 15A) for indicating which of the batteries 400, 500, 600 is receivable within the travel charger system 100. In some cases, the indicator panel 190 is a paper or thin plastic panel or a sticker having an adhesive backing to hold the indicator panel 190 within the recessed area 138. In other embodiments, the recessed area 138 may have retaining members (e.g., cutouts configured to engage opposing edges of indicator panel 190) for holding the indicator panel 190 within the recessed area 138.

The design of the charger base 110 allows for compatibility with multiple slide holders, such as the first slide holder 150, the second slide holder 250, and the slide holder 350. This modular approach enables the travel charger system 100 to accommodate different battery sizes and configurations while maintaining a common charging platform. In some instances, a user may swap out multiple slide holders depending on the battery to be charged. In some instances, a user may utilize only a single slide holder, though the use of a common charger base 110 still simplifies production by utilizing a common charger base 110 for multiple products and provides the user the ability to switch battery type without necessitating an entirely new charging platform.

FIG. 1A illustrates the travel charger system 100 with a first slide holder 150. The first slide holder 150 includes a housing 152 with a first longitudinal end 154 and a second longitudinal end 156. The housing 152 of the first slide holder 150 is configured to engage with the charger base 110 in multiple positions.

The first slide holder 150 includes a bracket 158 extending away from the charger base 110. In some instances, the bracket 158 is U-shaped and includes a first arm 160, a second arm 162, and a bridge 164 connecting the first arm 160 to the second arm 162. The U-shaped bracket 158 and the charger base 110 define a channel 166 therebetween. The channel 166 is configured to receive a battery 400, 500, 600 for charging. Each arm 160, 162 of the first slide holder 150 includes an aperture 168 configured to engage a latch mechanism 424, 524, 624 of a battery 400, 500, 600. In particular, the aperture 168 engages the latch mechanism 424 of a first battery 400 when the first slide holder 150 is in a first position, the latch mechanism 524 of a second battery 500 when the first slide holder 150 is in a second position, and the latch mechanism 624 of a third battery 600 when the first slide holder 150 is in a third position.

The first slide holder 150 is configured to slide along the charger base 110 between the first, second, and third positions. In particular, the slide holder 150 is positioned adjacent the second longitudinal end 116 of the charger base 110 and is moved along the longitudinal direction, with the rail 174 engaging the channel 130 of the charger base 110. The rail 174 is slidable within the channel 130 to move the first slide holder 150 relative to the charger base 110 between the first, second, and third positions. Each of the first, second, and third positions are positions in which the slide holder 150 is engaged with the charger base 110. The slide holder 150 is also configured to disengage the charger base 110 by sliding the slide holder over the second longitudinal end 116 of the charger base 110.

Each of FIGS. 6, 8, and 11 illustrate the first slide holder 150 in relation to the charger base 110 in various positions to accommodate different batteries 400, 500, 600, respectively. In accommodating the different batteries 400, 500, 600, the slide holder 150 is positioned to engage the latch mechanism 424, 524, 624 of the battery 400, 500, 600 to secure the battery 400, 500, 600 to the travel charger system 100 while the contacts 422, 522, 622 of the battery 400, 500, 600 are positioned in contact with the charging contacts 120 of the travel charger system 100. When the first slide holder 150 is adjusted from the first position to the second position, a distance between the charging contacts 120 of the charger base 110 and the aperture 168 of the first slide holder 150 is increased. This adjustability allows the first slide holder 150 to support different battery sizes in a charging state at the charging contacts 120. The charger base 110 may include multiple locking slots (FIG. 2), including an upper locking slot 132, a middle locking slot 134, and a lower locking slot 136. These locking slots 132, 134, 136 allow the first slide holder 150 to be held in the first, second, and third position respectively.

The first slide holder 150 is removably coupled to the charger base 110. This removable coupling allows for the first slide holder 150 to be replaced with other slide holders, such as the second slide holder 250 or the third slide holder to accommodate different battery or device configurations. The second and third slide holders 250, 350 are similarly removable. The first slide holder 150 (and the second slide holder 250) is precluded from supporting a battery 400, 500, 600 in a charging state (i.e., when the contacts 422, 522, 622 of the battery 400, 500, 600 are engaged with the charging contacts 120) when the latch mechanism 424, 524, 624 of the battery 400, 500, 600 is coupled to a portable radio 700. This configuration necessitates the use of a different slide holder, such as the third slide holder 350, for charging a battery 400, 500, 600 while it remains attached to the radio 700.

FIG. 1B illustrates the travel charger system 100 with a second slide holder 250. The second slide holder 250 is generally similar to the first slide holder 150, except as otherwise described, with like elements numbered similar to those of the first slide holder 150, incremented by 100. The second slide holder 250 includes a housing 252 with a first longitudinal end 254 and a second longitudinal end 256 and a bracket 258 (having first and second arms 260, 262 and a bridge 264) therebetween that extends away from the charger base 110, though the bracket 258 is sized differently than the bracket 158 of the first slide holder 150 to accommodate batteries having a different form factor. This may include, in some embodiments, a differently sized channel 266, a different location and/or size of the aperture 268 for engaging a latch of a battery, and a different location of the bracket 258 relative to the charger base 110.

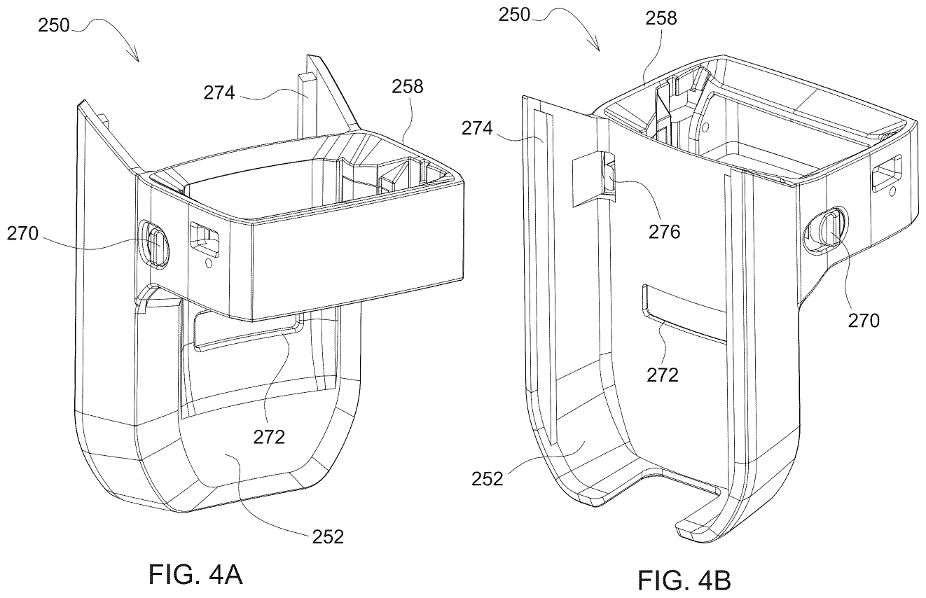

FIG. 4A and FIG. 4B illustrate perspective views of the second slide holder 250. The second slide holder 250 includes a locking mechanism 270 movable between an unlocked position and a locked position. When the locking mechanism 270 is in the unlocked position, the second slide holder 250 is movable along the charger base 110. When the locking mechanism 270 is in the locked position, the second slide holder 250 is precluded from movement along the charger base 110. In the locked position, a locking element 276 of the locking mechanism 270 is slid into one of the three locking slots 132, 134, 136 to secure the relative positioning between the slide holder 250 and the charger base 110. The locking mechanism 270 is manually movable between the unlocked and locked positions. A user engages the locking mechanism 270 to move (e.g., slide) it between the two positions, thereby sliding the locking element 276 in a similar motion. In some cases, the locking mechanism 270 is movable from the locked position to the unlocked position before adjusting the position of the second slide holder 250 relative to the charger base 110. After adjusting the position of the second slide holder 250, the locking mechanism is moved from the unlocked position back to the locked position to secure the second slide holder 250 in place.

In other embodiments, the locking mechanism 270 may be biased to the locked position (e.g., via a spring) and movable out of the locked position by user input to the locking mechanism 270. In still other embodiments, the locking mechanism 270 may be omitted and a detent (e.g., a ball detent) may hold the slide holder 250 in desired, discrete positions. While the locking mechanism 270 is illustrated with respect to the second slide holder 250, the first and third slide holders 150, 350 may incorporate a similar locking mechanism 270.

FIG. 1C illustrates a travel charger system 300 with a third slide holder 350. The slide holder 350 includes a housing 352 with a first longitudinal end 354 and a second longitudinal end 356. The housing 352 of the slide holder 350 is configured to engage with the charger base 110. The slide holder 350 includes a cradle 358 designed to accommodate a battery connected to a portable radio 700. The cradle 358 includes an interior volume 360 for receiving the battery and portable radio 700 combination. This configuration differs from the first slide holder 150 and the second slide holder 250, which are oriented for battery-only charging. The slide holder 350 includes a clip hook or clip latch 362 integrated into a front edge of the cradle 358.

As shown in FIGS. 14A-14B, the radio 700 includes a radio housing 710, an antenna 712, first and second control knobs 714, 716 located on a top edge of the housing 710, and a button 718 formed on a side of the radio 700. A battery 400 is coupled to the radio housing 710 to provide power to the radio 700. Other components and arrangements may be found on other radios. When a radio 700 (and attached battery 400) is received within the cradle 358, a strap 366 extends over the radio 700 (e.g., between the two control knobs 714, 716) to secure the radio 700 within the cradle 358. In particular, a first end of the strap 366 is attached to an attachment point 368 on the charger base 110 or the slide holder 350 (e.g., adjacent to the power input 118) and a clip 364 fixed to a second end of the strap 366 engages the clip latch 362 to tightly engage the radio 700 and prevent removal of the radio 700 from the cradle 538.

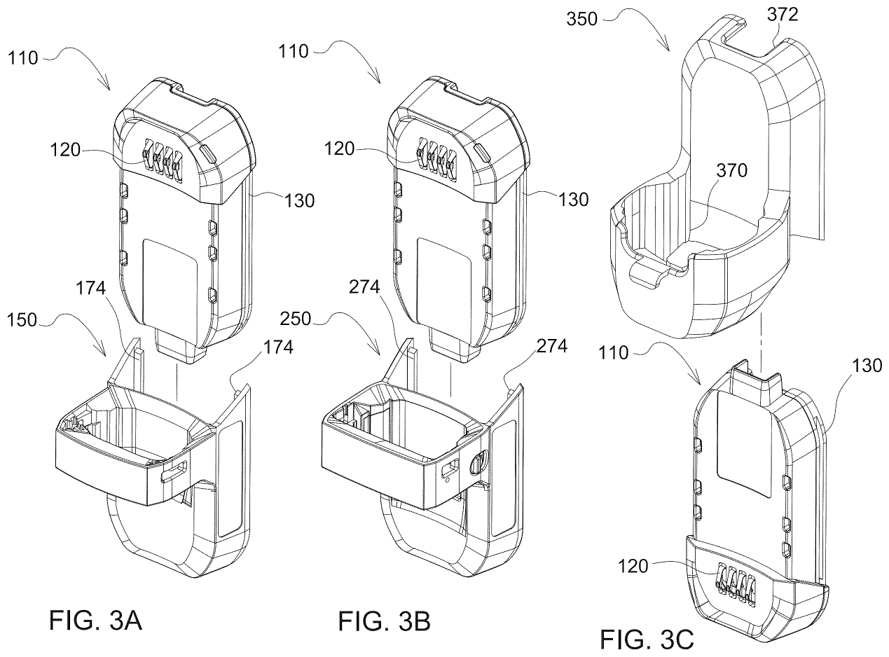

FIG. 14C provides a perspective view of the rear side of the slide holder 350. The slide holder 350 include a cutout 372 through which the charging contacts 120 of the charger base 110 are accessible within the interior volume 360 of the cradle 358 for a device placed within the cradle 358. Similar to the first and second slide holders 150, 250, the slide holder 350 includes two rails 374, one on each side, that extend longitudinally to serve as guides for engaging the charger base 110. In contrast to the first and second slide holders 150, 250, the normal use position of the travel charger system 300 orients the charger base 110 in an inverted orientation, as shown in FIGS. 3A, 3B, and 3C.

The design of the slide holder 350 allows for charging a battery (e.g., battery 400, 500, 600) while it remains attached to the portable radio 700. While the first and second slide holders 150 are precluded from supporting a battery in a charging state when the latch of the battery is coupled to a portable radio 700, the slide holder 350, with its cradle 358 configuration, is designed to accommodate this scenario.

The modular nature of the travel charger system 100 allows for easy interchange between the slide holders 150, 250, 350. This interchangeability provides flexibility in accommodating various charging scenarios, from standalone batteries to batteries attached to portable radios, and provides a common charger base 110 usable with a wide range of batteries. The charger base 110 is configured to accommodate various battery configurations, supporting the battery 400, the battery 500, and the battery 600, each with different dimensions and features.

FIG. 5A and FIG. 5B illustrate perspective views of the battery 400. The battery 400 includes a housing 410 with a first longitudinal end 412 and a second longitudinal end 414. An intermediate edge 416 extends substantially perpendicular to the longitudinal direction at a location between the first longitudinal end 412 and the second longitudinal end 414. The housing 410 includes an outside surface 418 (i.e., surface generally exposed when coupled with the radio 700) and an opposing inside surface 420 (i.e., surface generally not exposed when coupled with the radio 700).

The battery 400 includes contacts 422 accessible on the outside surface 418. The contacts 422 allow for electrical connection between the battery 400 and the charging contacts 120 of the charger base 110. The battery 400 also includes a latch mechanism 424 (as shown, two latch mechanisms 424, one on either side of the battery 400) with a latch 426 and a latch release 428. The latch 426 is located adjacent the intermediate edge 416 of the housing 410. The latch 426 physically engages the radio 700 to secure the battery 400 to the radio 700. The latch release 428 is depressed to disengage the latch 426 from the radio 700 and permit removal of the battery 400 from the radio 700. In some embodiments, such as is shown, both of the latch releases 428 of the two latch mechanisms 424 are simultaneously depressed to separate the battery 400 from the radio 700.

As shown in FIG. 6, the battery 400 is receivable within the travel charger system 100, held within the channel 166 formed by the bracket 158. The latch mechanisms 424 (and, in particular the latches 426 of the latch mechanisms 424) extend into the apertures 168 on either arm 160, 162 of the bracket to secure the battery 400 to the bracket 158 (and by extension, to the remainder of the travel charger system 100). The intermediate edge 416 also engages an edge of the bracket 158 to physically support and provide a stop against which the battery 400 engages when the latches 426 engage the apertures 168. The latch releases 428 are accessible and are movable to disengage the latches 426 from the bracket 158 and permit removal of the battery 400. As shown, the slide holder 150 is in the first position to support the battery 400 in a position in which the contacts 422 engage the charging contacts 120, the latches 426 engage the apertures 168, and the intermediate edge 416 engages the bracket 158. A gap 178 between an upper longitudinal end 154 of the slide holder 150 and a corresponding edge of the charger base 110 is substantially closed in the first position.

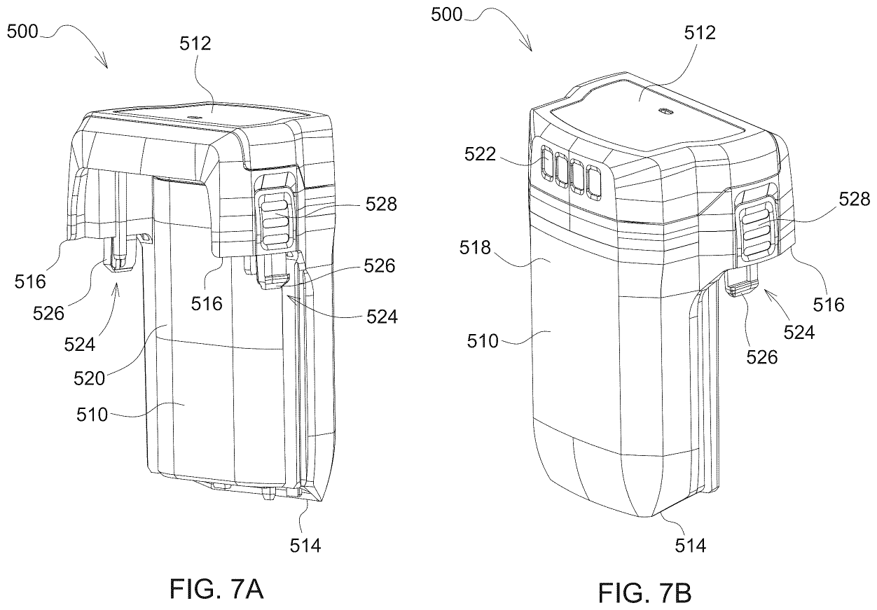

FIG. 7A and FIG. 7B illustrate perspective views of a second battery 500, having a different size than the first battery 400. This may include a different length, width, depth, latch mechanism 524, latch mechanism location, location of the contacts 522, and the like. Like elements are annotated with like reference numerals incremented by 100 relative to the first battery 400.

FIG. 8 illustrates the battery 500 receivable within the travel charger system 100, held within the channel 166 formed by the bracket 158. The latches 526 of the latch mechanisms 524 extend into the apertures 168 on either arm 160, 162 of the bracket 158 to secure the battery 500 to the bracket 158 (and by extension, to the remainder of the travel charger system 100). The intermediate edge 516 also engages an edge of the bracket 158 to physically support and provide a stop against which the battery 500 engages when the latches 526 engage the apertures 168. The latch releases 528 are accessible and are movable to disengage the latches 526 from the bracket 158 and permit removal of the battery 500. As shown, the slide holder 150 is in the second position to support the battery 500 in a position in which the contacts 522 engage the charging contacts 120, the latches 526 engage the apertures 168, and the intermediate edge 516 engages the bracket 158. A gap 178 between an upper longitudinal end 154 of the slide holder 150 and a corresponding edge of the charger base 110 is larger than when receiving the first battery 400, as the size and shape of the battery 500 and the location of the contacts 522 necessitate movement of the slide holder 150 from the first position to the second position to hold and charge the battery 500.

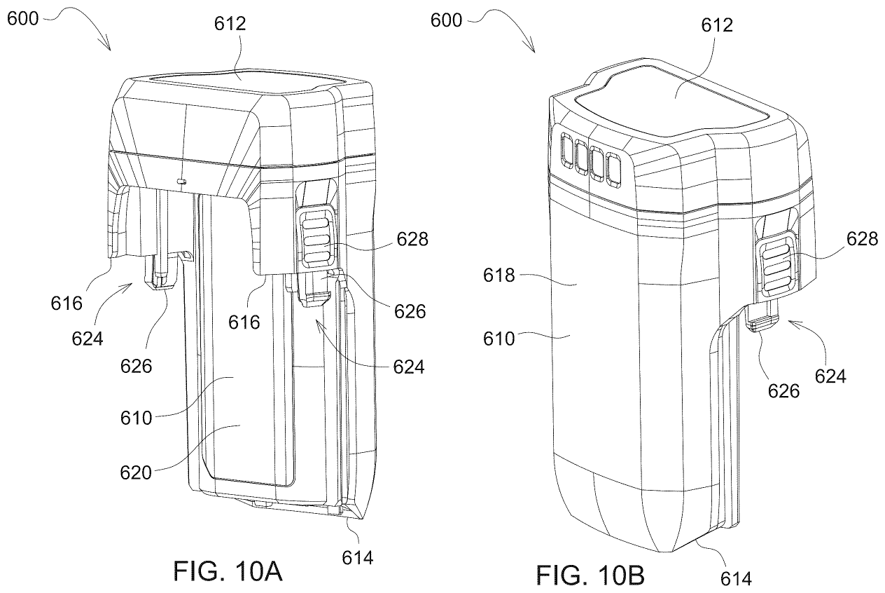

FIG. 10A and FIG. 10B illustrate perspective views of a third battery 600, having a different size than the first battery 400 and the second battery. This may include a different length, width, depth, latch mechanism 624, latch mechanism location, location of the contacts 622, and the like. Like elements are annotated with like reference numerals incremented by 200, relative to the first battery 400.

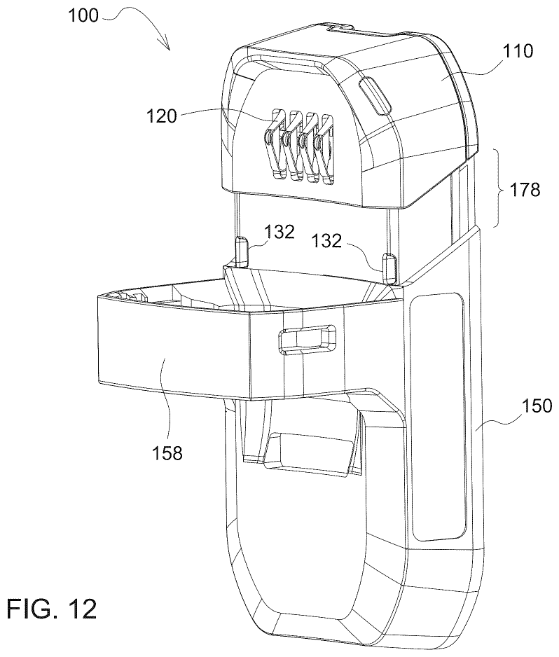

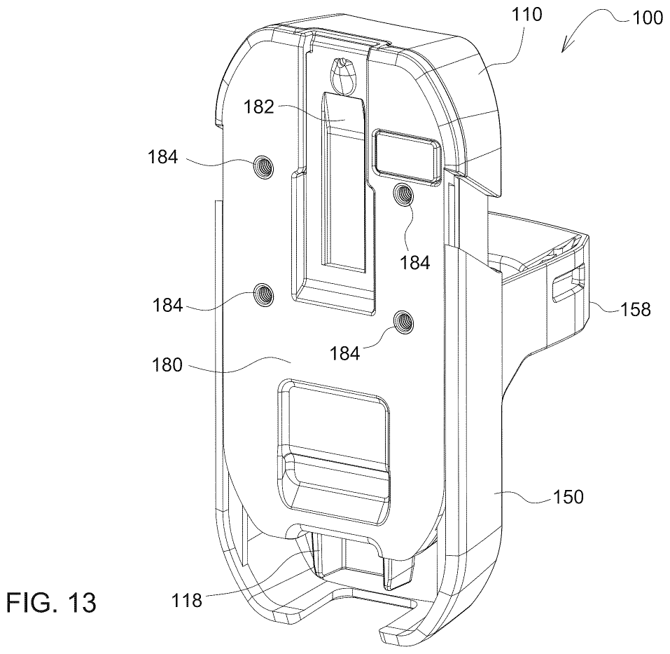

FIG. 11 illustrates the battery 600 receivable within the travel charger system 100, held within the channel 166 formed by the bracket 158. FIGS. 12-13 illustrate the system 100 with the battery 600 removed. The latches 626 of the latch mechanisms 624 extend into the apertures 168 on either arm 160, 162 of the bracket 158 to secure the battery 600 to the bracket 158 (and by extension, to the remainder of the travel charger system 100). The intermediate edge 616 also engages an edge of the bracket 158 to physically support and provide a stop against which the battery 600 engages when the latches 626 engage the apertures 168. The latch releases 628 are accessible and are movable to disengage the latches 626 from the bracket 158 and permit removal of the battery 600. As shown, the slide holder 150 is in the third position to support the battery 600 in a position in which the contacts 622 engage the charging contacts 120, the latches 626 engage the apertures 168, and the intermediate edge 616 engages the bracket 158. The gap 178 between the upper longitudinal end 154 of the slide holder 150 and a corresponding edge of the charger base 110 is larger than when receiving the first battery 400 or the second battery, as the size and shape of the battery 600 and the location of the contacts 622 necessitate movement of the slide holder 150 to the third position to hold and charge the battery 600.

Each of these batteries 400, 500, 600 interface with the travel charger system 100 in different positions, though are received within the channel 166 in a similar manner. With the first slide holder 150 coupled to the charger base 110, the battery 400, 500, or 600 is movable into the channel 166 by inserting a second longitudinal end 414, 514, 614 as a leading edge through the bracket 158. The second longitudinal end 414, 514, 614 is moved towards the second longitudinal end 116 of the charger base 110 until the latches 426, 526, 626 engage the aperture 168, the intermediate edge 416, 516, 616 engage the bracket 158, and the contacts 422, 522, 622 engage the charging contacts 120 in the charging state. While description is provided relative to the first slide holder 150, the second and third slide holders 250, 350 may operate in a similar manner when positioned on the charger base 110.

In operation, a method of charging a first battery 400 and a second battery 500 includes the following steps. First, the first battery 500 is inserted into the channel 166 defined between the bracket 158 of the slide holder 150 and the charger base 110 such that the contacts 422 of the first battery 400 engage the charging contacts 120 of the charger base 110 and the latch 426 of the first battery 400 engages the aperture 168 of the slide holder 150. Once charged (or charging of the second battery 500 takes precedence), the user removes the first battery 400 from the channel 166 and the slide holder 150 is moved relative to the charger base 110 from the first position to the second position to increase a distance between the contacts 120 of the charger base 110 and the aperture 168 of the slide holder 150. When in the second position, the second battery 500 is inserted between the bracket 158 of the slide holder 150 and the charger base 110 such that the contacts 522 of the second battery 500 engage the charging contacts 120 of the charger base 110 and the latch 526 of the second battery 500 engages the aperture 168 of the slide holder 150.

The first slide holder 150 may include a window 172. In some cases, the window 172 may allow viewing of battery indicator labels on the charger base 110. The window 172 may align with different portions of a battery indicator on the charger base 110 depending on the position of the first slide holder 150.

FIGS. 9A-9B illustrates a perspective view of the travel charger system 100 for charging the battery 500. The charger base 110 includes a lip 128 at its upper end, which helps guide and secure the battery 500 during insertion. The first slide holder 150 is attached to the charger base 110. As the lip 128 extends outward from the charger base 110 (perpendicular to the longitudinal direction L1, in the direction that the bracket 158 extends outward from the charger base 110) within the insertion path of the battery (as shown battery 500), the battery 500 is prevented from being linearly inserted into the channel 166. As such, the battery 500 is inserted into the channel 166 with an insertion direction D1 at an angle relative to its final orientation in which the battery 500 engages the contacts 120. This angled insertion prevents engagement between the charging contacts 120 and a portion of the battery 500, such as a leading edge of the battery 500 and the outside surface 518 of the battery. The lip 128 on the charger base 110 and the channel 166 in the bracket 158 of the first slide holder 150 provide a guided path for inserting the battery 500.

FIGS. 15A-15B illustrate an identification system for providing information to a user indicating which battery 400, 500, 600 is receivable and chargeable within the travel charger system 100 in the current position of the slide holder 150. The travel charger system 100 provides a visual indications for different battery types based on the position of the first slide holder 150. When the slide holder 150 is in a first position, a visual indication of the first battery 400 is provided through the window 172, as the window 172 is aligned with the first battery label 192 on the indicator panel 190 secured to the charger base 110. When the slide holder 150 is in a second position, a visual indication of the second battery 500 is provided through the window 172, as the window 172 is aligned with the second battery label 194 on the indicator panel 190 that is secured to the charger base 110. When the slide holder 150 is in a third position, a visual indication of the third battery 600 is provided through the window 172, as the window 172 is aligned with the third battery label 196 located on the indicator panel 190. The second battery label 194 can include a written indicator (e.g., words, numbers) of the make and/or model of the particular battery 400, 500, 600 and/or another visual indicator. For example, the three battery labels 192, 194, 196 may be color coded to provide a quick indication to a user without having to read the particular make and/or model text on the indicator panel 190. Further, the space between the three battery labels 192, 194, 196 may color coded (or blank) to indicate that the travel charger system 100 is not configured to charge a particular battery 400, 500, 600 when this portion of the indicator panel 190 is aligned with the window 172. The second slide holder 250 includes a similar window 272, though the locations of the battery labels associated with the window 272 and the batteries receivable within the second slide holder 250 may differ from those on the indicator panel 190.

When the second slide holder 250 is in a second position, a visual indication of a second battery may be provided. These visual indications may be visible through the window 272 of the second slide holder 250, aligning with different portions of a battery indicator on the charger base 110.

The charger base 110 includes a rear surface 180, as shown in FIG. 13. The rear surface 180 includes several features for mounting and connectivity. The power input 118 is located at a bottom of the rear surface 180, allowing for connection to a power source. The rear surface 180 includes a latch mount 182 positioned near the top center for receiving a latch. In some cases, the latch mount 182 may be used for securing the travel charger system 100 to a mounting surface or accessory. The rear surface 180 also includes multiple threaded apertures 184. These threaded apertures 184 may be distributed across the rear surface 180, as shown, with four threaded apertures 184 in a rectangular array. In some cases, the threaded apertures 184 may provide additional mounting options for the travel charger system 100.

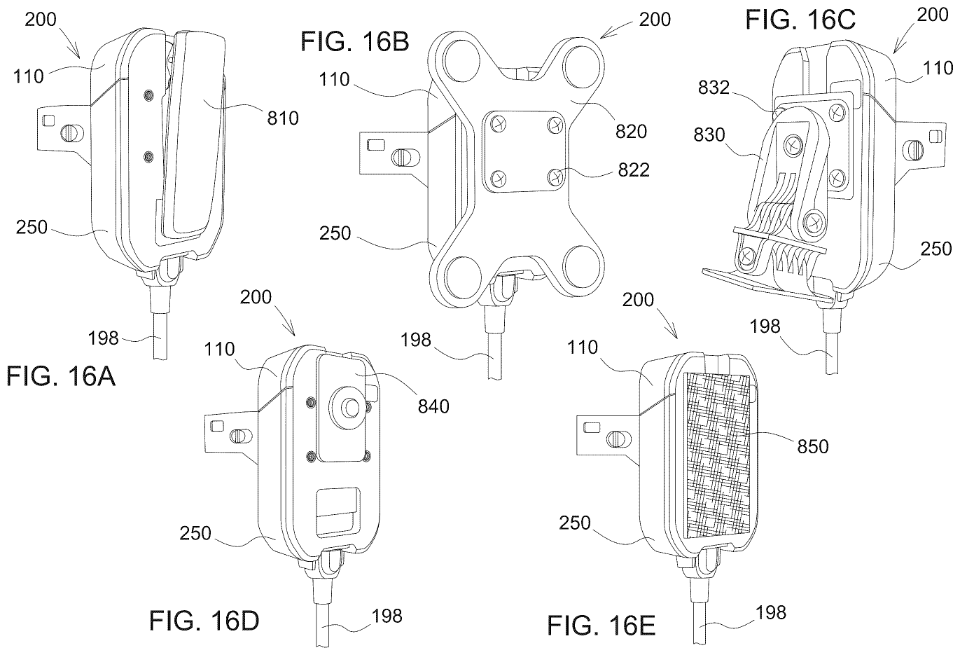

FIGS. 16A-16E illustrate various mounting configurations for the travel charger systems 100, 200, 300 (as shown, the second travel charger system 200). In some cases, the travel charger systems 100, 200, 300 may be compatible with multiple mounting options to accommodate different installation environments.

FIG. 16A shows the travel charger system 200 with a belt clip 810 attached to the latch mount 182 of the charger base 110. The belt clip 810 allows for portable use of the travel charger system 200, enabling users to carry the system on their person.

FIG. 16B depicts the travel charger system 200 with a magnetic mount 820 attached to the charger base 110. In some cases, the magnetic mount 820 is secured to the charger base 110 using fasteners 822 and the threaded apertures 184. The magnetic mount 820 allows for easy attachment and detachment of the travel charger system 200 from metal surfaces.

FIG. 16C illustrates the travel charger system 200 with a ram mount 830 attached. In some cases, the ram mount 830 may be connected to the charger base 110 via fastener 832 received within the threaded apertures 184. The ram mount 830 provides adjustable positioning options for the travel charger system 200.

FIG. 16D shows the travel charger system 200 with a stud mount 840 attached to the latch mount 182 of the charger base 110. The stud mount 840 allows for fixed installation of the travel charger system 200 in vehicles or other environments.

FIG. 16E depicts the travel charger system 200 with a hook and loop mount 850 attached to the back of the charger base 110 (e.g., via an adhesive). The hook and loop mount 850 provide a removable attachment option for the travel charger system 200.

A number of implementations have been described. Nevertheless, it will be understood that various modifications may be made without departing from the spirit and scope of the disclosure. Accordingly, other implementations are within the scope of the following claims.

1. A travel charger system for a first battery having contacts and a latch to secure to a first portable radio and a second battery having contacts and a latch to secure to a second portable radio, the travel charger system comprising:
a charger base having charging circuitry, charging contacts, and a power input, and
a slide holder configured to engage the charger base in a first position to support the first battery in a charging state and a second position to separately support the second battery in a charging state, the slide holder having an aperture configured to engage the latch of the first battery in the first position and the latch of the second battery in the second position.

2. The travel charger system of claim 1, wherein the slide holder is configured to slide along the charger base from the first position to the second position.

3. The travel charger system of claim 2, further comprising a locking mechanism movable between an unlocked position in which the slide holder is movable along the charger base between the first position to the second position and a locked position in which the slide holder is precluded from movement along the charger base.

4. The travel charger system of claim 1, wherein the slide holder includes a U-shaped bracket extending away from the charger base, the U-shaped bracket and charger base defining a channel therebetween, wherein the channel is configured to separately receive the first battery when the contacts of the first battery engage the charging contacts and the second battery when the contacts of the second battery engage the charging contacts.

5. The travel charger system of claim 1, wherein the charging contacts extend through one or more openings formed in a planar surface of the charger base, the travel charger system further comprising a lip positioned adjacent the charging contacts of the charger base and protruding outward relative to the planar surface, wherein the lip prevents insertion of the first battery and the second battery into the slide holder in a direction parallel to the planar surface to prevent engagement between the charging contacts and a portion of the battery.

6. The travel charger system of claim 1, further comprising:
a battery indicator having a first portion that provides information for the first battery and a second portion that provides information for the second battery, the battery indicator coupled to the charger base; and
an indicator aperture formed in the slide holder,
wherein, in the first position, the indicator aperture aligns with the first portion of the battery indicator and the slide holder covers the second portion, and
wherein, in the second position, the indicator aperture aligns with the second portion of the battery indicator and the slide holder covers the first portion of the battery indicator.

7. The travel charger system of claim 1, wherein the charger base includes a front surface at the charging contacts and a rear surface opposite the front surface, wherein the slide holder engages the front surface and the rear surface of the charger base.

8. A method of charging a first battery and a second battery, the method comprising the following steps:
inserting the first battery into a channel defined between a slide holder and a charger base such that contacts of the first battery engage charging contacts of the charger base and a latch of the first battery engages an aperture of the slide holder;
removing the first battery from the channel;
moving the slide holder relative to the charger base from a first position to a second position to increase a distance between the contacts of the charger base and the aperture of the slide holder; and
inserting the second battery between the slide holder and the charger base such that contacts of the second battery engage the charging contacts of the charger base and a latch of the second battery engages the aperture of the slide holder.

9. The method of claim 8, further comprising, prior to moving the slide holder relative to the charger base, moving a locking mechanism from a locked position to an unlocked position to permit movement of the slide holder relative to the charger base.

10. The method of claim 9, further comprising, prior to inserting the second battery between the slide holder and the charger base, moving the locking mechanism from the unlocked position to the locked position to preclude movement of the slide holder relative to the charger base.

11. The method of claim 8, wherein inserting the first battery into the channel includes inserting the first battery into the channel at an angle relative to an orientation of the first battery when the contacts of the first battery engage charging contacts of the charger base and the latch of the first battery engages the aperture of the slide holder such that engagement between the charging contacts and a leading edge of the first battery is prevented.

12. The method of claim 8, wherein removing the first battery from the channel includes disengaging the latch of the first battery from the aperture of the slide holder.

13. The method of claim 8, further comprising providing a visual indication of the first battery when the slide holder is in the first position and providing a visual indication of the second battery when the slide holder is in the second position.

14. A travel charger system configured to perform the method of claim 8.

15. A modular charging system for a battery of a portable radio, the battery having a latch to couple the battery to the portable radio, the modular charging system comprising:
a charger base comprising charging circuitry and charging contacts;
a first slide holder removably coupled to the charger base at a first position and configured to support the battery in a charging state at the charging contacts, the slide holder having an aperture configured to engage the latch of the battery in the first position; and
a second slide holder separate from the first slide holder and removably coupled to the charger base and configured to support the battery in a charging state at the charging contacts when the latch of the battery is coupled to the portable radio,
wherein the first slide holder is precluded from supporting the battery in a charging state when the latch of the battery is coupled to the portable radio.

16. The modular charging system of claim 15, wherein each slide holder of the first and second slide holders includes a locking mechanism movable between an unlocked position in which the respective slide holder is movable along the charger base and a locked position in which the respective slide holder is precluded from movement along the charger base.

17. The modular charging system of claim 15, wherein the first slide holder is adjustable relative to the charger base from the first position to a second position in which a distance between the charging contacts of the charger base and the aperture of the first slide holder is increased, wherein the first slide holder is configured to be held in the first position and the second position.

18. The modular charging system of claim 15, wherein the first slide holder includes a U-shaped bracket, wherein the U-shaped bracket and charger base define a channel therebetween, wherein the channel is configured to receive the battery when the battery is in the charging state.

19. The modular charging system of claim 18, wherein the second slide holder includes a cradle configured to receive the battery and the portable radio.

20. The modular charging system of claim 19, wherein the charger base includes a first lengthwise end and a second lengthwise end, opposite the first lengthwise end, wherein the charging contacts are located nearer the first lengthwise end than the second lengthwise end, wherein, with the first slide holder coupled to the charger base, the battery is movable towards the second lengthwise end to engage the charging contacts in the charging state, and wherein, with the second slide holder coupled to the charger base, the battery is movable towards the first lengthwise end to engage the charging contacts in the charging state.
